(19) United States
(12) Patent Application Publication
(10) Pub. No.: US 2023/0245235 A1
(43) Pub. Date: Aug. 3, 2023

(54) CROSS-FUNCTIONAL PORTFOLIO DATABASE MANAGEMENT SYSTEMS AND METHODS

(71) Applicant: Zurich Insurance Company Ltd., Zurich (CH)

(72) Inventors: Kirill Pankratov, Zurich (CH); Stefan Ackermann, Schlieren (CH); Prezmyslaw Rymaszewski, Baar (CH)

(73) Assignee: Zurich Insurance Company Ltd., Zurich (CH)

(21) Appl. No.: 18/146,173

(22) Filed: Dec. 23, 2022

Related U.S. Application Data
(60) Provisional application No. 63/358,320, filed on Jul. 5, 2022.
(60) Provisional application No. 63/305,486, filed on Feb. 1, 2022.

(51) Int. Cl. G06Q 40/06; G06F 16/248; G06F 16/2455; G06Q 50/16; G06Q 30/02

(52) U.S. Cl. CPC G06Q 40/06; G06F 16/248; G06F 16/24564; G06Q 50/16; G06Q 30/0278

(57) ABSTRACT

A method for populating a portfolio management database with one or more data records from at least one database. The populating the portfolio management database may include altering at least a portion of the data records and selecting a portion of the data records based on rules for the portfolio management database. A search string associated with a search of the portfolio database management database is received and a search of the portfolio database based on the search string is conducted. The results of the searching are output to a user interface.

### RELATED APPLICATIONS

The present application claims the benefit of U.S. Provisional Patent Application No. 63/305,486 filed Feb. 1, 2022 and U.S. Provisional Patent Application No. 63/358,320 filed Jul. 5, 2022, the entire disclosures of which are hereby incorporated by reference herein in their entirety for all purposes.

### FIELD

The present disclosure relates generally to a management system. In particular, the present disclosure relates to computer database and management systems that integrate and standardize different databases and generates a unified interface.

### BACKGROUND

Historically, commercial insurance portfolio management has focused on analyzing the information within functional siloes. For example, in real estate and property settings, claims information has been analyzed on a standalone basis. That is a portfolio manager may be limited to claims within a specific portfolio, e.g., client. The portfolio manager may not be able to analyze industry or other general topics, outside the specific portfolio for the location at which the claim has occurred. Information required to perform such an analysis may be stored in other systems such as pricing and risk engineering tools and databases. Often, these systems, while associated with an aspect of the insurance industry, store and index data using different types of schemes and standards. As such, a portfolio manager may not be able to easily identify and/or access all the relevant information to provide complete and accurate advice to customers.

Given that many customers insure a significant number of locations representing a diverse set of industries, e.g., from office buildings to specialized production plants, it would be desirable to integrate the information from various sources to provide a complete picture for analysis.

### SUMMARY

One exemplary embodiment of the subject disclosure is directed to a computer-implemented method for outputting result data to an output device, the method including: using at least one hardware processor for extracting code for: populating a portfolio management database with one or more data records from at least one database, where populating the portfolio management database includes at least one of: altering at least a portion of the one or more data records, and selecting a portion of the one or more data records based on one or more rules for the portfolio management database. The method includes receiving at least one search string associated with a search of the portfolio database management database. The method also includes searching the portfolio database based on the at least one search string. The method includes generating result data based, at least in part, on the searching and outputting result data to a user interface.

Another embodiment is directed to the computer-implemented method, where populating the portfolio management database comprises initially populating the portfolio management database.

Another embodiment is directed to the computer-implemented method, where populating the portfolio management database comprises updating the portfolio management database.

Another embodiment is directed to computer-implement method, where the one or more data records include property valuations and the method further includes comparing a current property valuation to a historic property valuation; determining that the current property valuation differs from the historic property valuation; and generating a report of a difference in the current property valuation and the historic property valuation.

Another embodiment is directed to the computer-implemented method, where populating the portfolio management database includes: determining a set of candidate data records from the one or more data records, where the determination of the set of candidate data records is based, at least in part, on a standardization of one or more geographic location identifiers of the one or more data records; filtering the set of candidate data records, where filtering the set of candidate records is based, at least in part, on a set of relevancy rules for the portfolio management database; converting the set of candidate data records, which were filtered, into one or more portfolio data records; and linking one or more portfolio data records based, at least in part, on the converting.

Another embodiment is directed to the computer-implemented method, where determining the set of candidate data records includes: selecting a first data record from the one or more data records; determining whether a first geographic location identifier in the first data record can be standardized into a format of the portfolio management database; if the first geographic location identifier can be standardized, standardizing the first geographic location identifier according to the format of the portfolio management database; assigning a first quality metric to the first geographic location identifier, which was standardized, identifier based, at least in part, on one or more quality metric rules; and marking the first data record for inclusion in the set of candidate data records.

Another embodiment is directed to the computer-implemented method, where determining the set of candidate data records includes: if the first geographic location identifier cannot be standardized, determining whether the first geographic location identifier is similar to at least one valid geographic location based on one or more geographic location identifier rules; if the first geographic location identifier is not similar, discarding the first data record; if the first geographic location identifier is similar, maintaining the geographic location identifier for the first data record; and assigning a second quality metric to the first geographic location identifier.

Another embodiment is directed to the computer-implemented method, where the searching further includes selecting one or more matching candidates from the portfolio management database, based, at least in part, on a set of business rules.

Another embodiment is directed to the computer-implemented method, where the set of business rules include insurance-specific policy characteristics.

Another embodiment is directed to the computer-implemented method, where the set of business rules include location characteristics.

Another embodiment is directed to the computer-implemented method, where the searching includes utilizing a confidence score.

Another embodiment is directed to the computer-implemented method, where the searching combines complex data and granular data.

Another embodiment is directed to the computer-implemented method, further including receiving an update to the at least one search string; generating new result data based, at least in part, on the update to the at least one search string; and updating the user interface based on the new result data.

Another embodiment is directed to a method for consolidating data records from multiple databases, including receiving one or more data records to be transferred from at least one database to a portfolio management database. The method includes determining a set of candidate data records from the one or more data records. The determination of the set of candidate data records is based on at least a standardization of one or more geographic location identifiers of the one or more data records. The method also includes filtering the set of candidate data records. Filtering the set of candidate records is based on a set of relevancy rules for the portfolio management database. Further, the method includes converting the filtered set of candidate data records into one or more portfolio data records. The method includes linking a set of the one or more portfolio data records and outputting the linked sets of portfolio data records to a user device.

Another embodiment is directed to the method for consolidating data records from multiple databases, where determining the set of candidate data records includes: selecting a first data record from the one or more data records; determining whether a first geographic location identifier in the first data record can be standardized into a format of the portfolio management database; if the first geographic location identifier can be standardized, standardizing the first geographic location identifier according to the format of the portfolio management database; assigning a first quality metric to the first geographic location identifier, which was standardized, based on one or more quality metric rules; and marking the first data record for inclusion in the set of candidate data records.

Another embodiment is directed to the method for consolidating data records from multiple databases, where the selecting further comprises selecting one or more matching candidates from the portfolio management database, based, at least in part, on a set of business rules.

Another embodiment is directed to the method for consolidating data records from multiple databases, where determining the set of candidate data records includes: if the first geographic location identifier cannot be standardized, determining whether the first geographic location identifier is similar to at least one valid geographic location based on one or more geographic location identifier rules; if the first geographic location identifier is not similar, discarding the first data record; if the first geographic location identifier is similar, maintaining the geographic location identifier for the first data record; and assigning a second quality metric to the geographic location identifier.

Another embodiment is directed to a system for consolidating data records, including: one or more memories configured to store representations of data in an electronic form; and one or more processors, operatively coupled to one or more of the memories, the processors configured to access the data and process the data to: select a data record to be transferred from a first database to a portfolio management database; determine whether a geographic location identifier in the data record can be standardized into a format of the portfolio management database; if the geographic location identifier can be standardized, standardizing the geographic location identifier according to the format of the portfolio management database; assign a first quality metric to the geographic location identifier, which was standardized, identifier based on one or more quality metric rules; mark the data record as a candidate data record; and output the marked data record to a user device.

Another embodiment is directed to the system, where the selecting further includes selecting one or more matching candidates from the portfolio management database, based, at least in part, on a set of business rules.

Another embodiment is directed to the system, where the set of business rules include insurance-specific policy characteristics.

Another embodiment is directed to the system, further including: if the geographic location identifier cannot be standardized, determining whether the geographic location identifier is similar to at least one valid geographic location based on one or more geographic location identifier rules; if the geographic location identifier is similar, discarding the data record; and if the geographic location identifier is not similar, maintaining the geographic location identifier for the candidate data record and assigning a second quality metric to the geographic location identifier.

In accordance with another exemplary embodiment, a portfolio manager may easily identify and access all the relevant information to provide complete and accurate advice to customers as well as manage the portfolio for profitability.

### BRIEF DESCRIPTION OF THE SEVERAL VIEWS OF THE DRAWINGS

The foregoing summary, as well as the following detailed description of the exemplary embodiments of the subject disclosure, will be better understood when read in conjunction with the appended drawings. For the purpose of illustrating the subject disclosure, there are shown in the drawings exemplary embodiments. It should be understood, however, that the subject disclosure is not limited to the precise arrangements and instrumentalities shown.

In the drawings:

FIG. 1 illustrates a generalized schematic view of an environment in accordance with an exemplary embodiment of the present disclosure;

FIG. 2 illustrates a generalized schematic view of systems and devices utilized in the insurance environment in accordance with an exemplary embodiment of the present disclosure;

FIG. 3 illustrates a flow diagram of a portfolio management process in accordance with an exemplary embodiment of the present disclosure;

FIG. 4 illustrates a flow diagram of a process for integrating data records of various formats into a portfolio management database in accordance with an exemplary embodiment of the present disclosure;

FIG. 5 illustrates a flow diagram of a process for selecting candidate data records for inclusion into a portfolio management database in accordance with an exemplary embodiment of the present disclosure;

FIGS. 6A-6C illustrate graphical user interfaces in accordance with an exemplary embodiment of the present disclosure; and

FIG. 7 is a schematic block diagram of a computer system suitable for implementing methods in accordance with exemplary embodiments of the present disclosure.

### DETAILED DESCRIPTION OF THE DISCLOSURE

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure. Additionally, the term “a,” as used in the specification, means “at least one.”

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

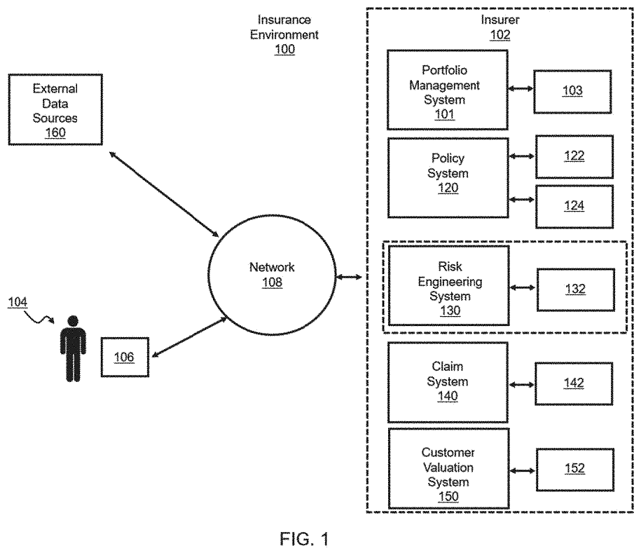

FIG. 1 illustrates an insurance environment 100 in accordance with an exemplary embodiment of the present disclosure. The insurance environment 100 includes internal and external data resources for providing insurance services and for storing and marinating the data associated with the services. The insurance environment 100 includes a portfolio management system 101 that operates to standardize and centralize data associated with the insurance environment 100 and provide an interface for accessing the data.

As illustrated in FIG. 1, the insurance environment 100 includes an insurer 102 that provides insurance services. In general, the insurer 102 offers one or more insurance products to one or more customers 104 that operate to protect against financial loss. The insurance products can cover any type of entity, thing, or item (hereinafter insured item) in which risk against loss can be managed. For example, the insurance products can cover property (e.g., vehicles, goods, merchandise, etc.), real property (e.g., land, structures, buildings, etc.), persons (e.g., health, life, etc.), financial instruments (e.g., securities, bonds, etc.), and the like.

The insurer 102 can include one or more electronic and/or computer systems that support the insurance environment 100 and provide an interface for the customers 104 to view, purchase, and exercise the insurance products. The customers 104 can use one or more user devices 106 to communicate with the systems of the insured 102, via a network 108. The network 108 can include one or more networks such as a public internet, a private intranet, and combinations thereof.

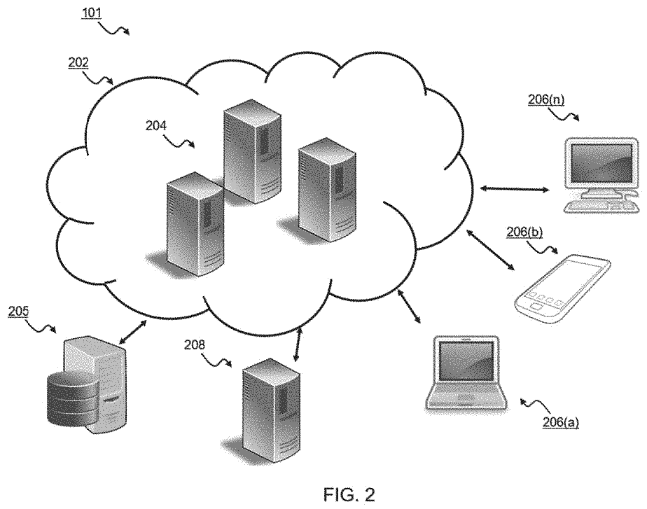

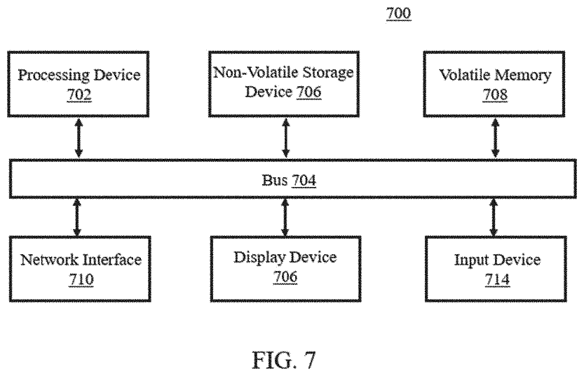

The insurer 102 can include a number of systems that function to provide and manage one or more insurance products and the data associated with the one or more insurance products. The insurer 102 can include the portfolio management system 101, a policy system 120, a risk engineering system 130, a claim system 140, and a customer valuation system 150. Any of these systems can be embodied in one or more computers or computing devices, as described below in FIGS. 2 and 7 in further detail. Additionally, while these systems are illustrated as being separate systems, one or more of these systems can be integrated into a single system. Likewise, the functionality or process of one system can be performed by another system in the insurer 102. Additionally, while the above systems are shown as being within an “insurer”, one skilled in the art will realize that these systems may be geographically dispersed and communicate view one or more electronic networks.

In embodiments, the policy system 120 operates to offer, manage, and track the insurance products offered by the insurer 102. The policy system 120 also operates to track insurance policies that have been acquired by customers, e.g., the customer 104. As described herein, an insurance policy is a contract that details the conditions and circumstances under which the insurer 102 will compensate the insured (e.g., the customer), or their designated beneficiary or assignee, for damage or loss to an insured item. To offer, manage, and track the products and policies, the policy system 120 can include a product database 122 and a policy database 124. The product database 122 stores all the relevant information about the products offered by the insurer 102. The policy database 124 stores all the relevant information about the policies currently issued to customers, e.g., customer 104. The insurer 102 can also include pricing data that may be used to determine coverage amounts and policy financial information. While FIG. 1. illustrates a single product database 122 and a single policy database 124, one skilled in the art will realize that the product database 122 and/or the policy database 124 can include multiple databases that can be geographically dispersed.

In embodiments, the risk engineering system 130 operates to evaluate and determine the risk associated with an insured item that is or may be insured by the insurer 102. That is, to provide an insurance product, the insurer 102 determines the risk associated with an insured item. This includes determining the types of loss or damage that may occur for an insured item, the likelihood the damage or loss may occur, the frequency of the damage or loss may occur, and the cost associated with compensating for the damage or loss. The risk information can be determined using historic data for the insured item. The risk engineering system 130 can include a risk engineering database 132 that stores all the relevant information used to perform risk assessments. While FIG. 1. illustrates a single risk engineering database 132, one skilled in the art will realize that the risk engineering database 132 can include multiple databases that can be geographically dispersed.

In embodiments, the claim system 140 operates to resolve, manage, and track claims made by customers, e.g., customer 104, against the insurance policies. As described herein, a claim is a request by a customer to cover a loss, which may be potentially covered by an insurance policy. The claim system 140 can include a claim database 142 that stores all the relevant information used to perform risk assessments. While FIG. 1. illustrates a single claim database 142, one skilled in the art will realize that the claim database 142 can include multiple databases that can be geographically dispersed.

In embodiments, the customer valuation system 150 operates to resolve, manage, and track valuations of property of customers, e.g., customer 104. As described herein, a valuation of property is a monetary value assigned to an item of property based on an estimated worth and value of an item of property. In embodiments, the valuation of an item of property can be provided by a customer 104. In embodiments, the valuation of an item of property can be determined by an entity of the insurer 102, e.g., assessor, broker, underwriter, etc.

The customer valuation system 150 can include a customer valuation database 152 that stores all the relevant information associated with the valuations of the property of a customer including the values assigned items and the methods and data used to assign the values. Additionally, the customer valuation database 152 can store historical valuations of the property, e.g., previous valuations of the property. While FIG. 1. illustrates a single customer valuation database 152, one skilled in the art will realize that the customer valuation database 152 can include multiple databases that can be geographically dispersed.

In embodiments, the portfolio management system 101 operates to integrate the data generated and stored by the policy system 120, the risk engineering system 130, the claim system 140, and the customer valuation system 150. The portfolio management system 101 is configured to retrieve data from the product database 122, the policy database 124, the risk engineering database 132, the claim database 142, and the customer valuation database 152 convert the data to a standardized format, which can be stored in a portfolio database 103. The portfolio management system 101 also operates to provide an interface that allows a user to access, retrieve, and analyze the data stored in the portfolio database 103.

The portfolio management system 101 operates to integrate the data from the policy system 120, the risk engineering system 130, the claim system 140, and the customer valuation system 150 to provide a robust platform that utilizes data that may not be accessible by each system. For example, insuring property may be volatile with damages and losses being financially significant. Historically, loss location information within the insurance industry has not always been captured very accurately, which led to challenges in identifying which physical locations in the broad and diverse customer portfolio have faced a loss. Thus, a portfolio manager can easily identify and access all the relevant information to provide complete and accurate advice to customers as well as manage the portfolio for profitability.

Industry portfolio management has frequently followed two approaches: conduct a detailed analysis of large loss events, which given their smaller scale, could be analyzed case by case; and focused on the analysis of insurance trends at a policy level. Both approaches may experience drawbacks in providing meaningful results for the analysis. Because of its focus on a single event, the first approach has a limited possibility to understand broader trends across different events. The second approach may not be granular enough to spot insurance portfolio trends. That is, hundreds of thousands of insured locations are grouped for the analysis, and the trends may be “averaged out”. Similar issues can occur when analyzing Risk Engineering information (e.g., has a Risk Engineer assessed an insured location or not, and what was the outcome of the on-site assessment?)

As such, large multi-year data series are required to analyze profitability and define underwriting strategy. Additionally, large commercial customers wish to frequently insure very diverse portfolios consisting of different types of locations spread globally. For instance, a complex portfolio of buildings may include manufacturing plants, office buildings, residential dwellings, etc.

The classification of the large-scale data has typically been addressed by using geocoding services available in the public market. Claim and insured locations are applied to a geocoding service, which returns a cleaned version of the address and a geocode. This approach may deliver suboptimal results. Commercial locations are typically built in less populated geographical areas with limited geocoding accuracy. Custom rules applied by third-party, geocoding companies are frequently skewed toward retail property as commercial locations are frequently not publicly accessible (e.g., by local map users who refine the maps), which leads to lower accuracy. In highly populated areas, e.g., New York City, the geocoding approach relies on latitudes and longitudes matching, which produces unreliable results to the population density and the number of potential matching candidates. Moreover, because external geocoders do not have access to the internal information of an insurer, geocoding approaches are not leveraging other building characteristics, for instance, insured and claim values, and location level industry. For instance, internal customer names for an insured location (e.g., Factory “ABC”) present on the claims in pricing data is frequently not available in the public domain and are used by external geocoding services.

Moreover, in insurer databases, themselves, there are several data quality issues and inconsistencies over time and space. Most customers resubmit their insured portfolio lists once per year with data quality changing from year to year. In some cases, claims adjusters did not necessarily have access to all details of the insured locations, which significantly impacted claim address data quality. Additionally, buildings and addresses change over time which limits the ability to link an old claim to a new location, even if it is the same one.

The portfolio management system 101 addresses these drawbacks by consolidating, standardizing, filtering, and linking the data from the product database 122, the policy database 124, the risk engineering database 132, the claim database 142, and the customer valuation database 152. To achieve scale and full end-to-end automation, the portfolio management system 101 selects matching candidates through a set of business rules, e.g., insurance-specific policy and location characteristics, to narrow down the number of potential matches. The portfolio management system 101 utilizes confidence scores for different types of matches to leverage different inputs depending on the specific analytical use case, e.g., broad matching for initial trend analysis vs strict matching for regulatory purposes. The portfolio management system 101 can combine complex and granular data allowing the less data-savvy users to intuitively explore the results, e.g., type a hurricane name and review risk engineering visit results on the locations that are affected by that hurricane.

In embodiments, the systems of the insurer 102, e.g., the portfolio management system 101, can communicate with one or more external data sources 150, via the network 108. The external data source 150 can be any electronic data source that includes information that might be relevant to the operations of the insurer 102. For instance, the external data sources 160 can include geographic location data, historical climate data, financial information, property valuation information, and the like from external data sources such as google maps, commercial data services, governmental data sources, etc.

In embodiments, the customer valuation system 150 can be configured to provide analysis and evaluation of property valuations of the customer. The customer valuation system 150 can be configured to compare the property valuation provided for an item of property of the customer to historical property valuations for that specific item of property. Additionally, the customer valuation system 150 can be configured to compare the property valuation provided for an item of property of the customer to property valuations for that specific item of property from external data sources, e.g., governmental assessments of property valuations. If the provided valuation of property differs, the customer valuation system 150 can be configured to generate an alert and/or report that indicates a property valuation from an item of property may require review. The alert and/or report can be provided to the customer 106 and/or an entity associated with the insurer, e.g., broker, agent underwriter, assessor, etc.

FIG. 2 illustrates various systems and devices that can implement the portfolio management system 101 in accordance with an exemplary embodiment of the present disclosure. The portfolio management system 101 can include internal and external data resources for implementing and executing the data consolidation, standardization, and analysis as described above and below in further detail. While FIG. 2 is described for the portfolio management system 101, one skilled in the art will realize that a similar architecture can be utilized for the other system of the insurer 102, e.g., the policy system 120, the risk engineering system 130, the claim system 140, and the customer valuation system 150, as shown in FIG. 1.

The portfolio management system 101 can include a data management system 202 that communicates with one or more user devices 206(a) . . . (n), where “n” is any suitable number (generally 206 herein), via a network (e.g., the network 108 and/or any other computer network). In some embodiments, the data management system 202 can be implemented as a physical data management system. In some embodiments, the data management system 202 can be implemented as a cloud-based data management system, which is hosted on cloud computer services. As used herein, a “cloud” or “cloud computing service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In any embodiment, the data management system 202 can include one or more servers 204 such as application servers, database servers, and data servers. The user device 204 can include one or more devices associated with user profiles of the portfolio management system 101, such as a smartphone, tablet, or other mobile device and/or a personal computer. The portfolio management system 101 can include external resources such as an external application server 208 and/or an external database server 205. The various elements of the portfolio management system 101 can communicate via various communication links through one or more networks. An external resource can generally be considered a data resource owned and/or operated by an entity other than an entity that utilizes the portfolio management system 101 and/or the user device 206. The user devices 206 also can present, on a display device, a graphical user interface (GUI) that may display the output data to a user, shown as 104, herein.

The data management system 202 can be web-based. In some embodiments, the user device 206 can access the data management system 202 via an online portal set up and/or managed by one or more of the servers 204, e.g., the application server. In some embodiments, the user device 206 can include one or more applications that access the services of the data management system 202 via one or more application programing interfaces (APIs). The portfolio management system 101 and the user devices 206 can communicate through one or more networks, e.g., the network 108, which can include one or more networks such as a public internet, a private intranet, and combinations thereof. Elements of portfolio management system 101, such as the database server 204 and/or the application servers 208, can be physically housed at a location remote from an entity that owns and/or operates the portfolio management system 101. For example, various elements of the portfolio management system 101 can be physically housed at a public service provider such as a web services provider. Elements of the portfolio management system 101 can be physically housed at a private location, such as at a location occupied by the entity that owns and/or operates the portfolio management system 101.

The communication links by which the portfolio management system 101 and the user devices 206 communicate can be direct or indirect. A direct link can include a link between two devices where information is communicated from one device to the other without passing through an intermediary. For example, the direct link can include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link can include a cable on a bus network. “Direct,” when used regarding the communication links, can refer to any of the aforementioned direct communication links.

An indirect link can include a link between two or more devices where data can pass through an intermediary, such as a router, before being received by an intended recipient of the data. For example, the indirect link can include a wireless fidelity (WiFi) connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long-term evolution (LTE) standard, and so forth. “Indirect,” when used regarding the communication links, can refer to any of the aforementioned indirect communication links.

In embodiments, various components of the portfolio management system 101 and the user devices 206 can include data storage and/or processing capabilities. Such capabilities can be rendered by various electronics for processing and/or storing electronic signals. For example, the portfolio management system 101 and the user devices 206 can include one or more processing devices and one or more memory devices. The processing device can have volatile and/or persistent memory. The memory device can have volatile and/or persistent memory. The processing device can have volatile memory and the memory device can have persistent memory. Memory in the processing device can be allocated dynamically according to variables, variable states, static objects, and permissions associated with objects and variables in the portfolio management system 101 and the user devices 206. Such memory allocation can be based on instructions stored in the memory device. Memory resources at a specific device can be conserved relative to other systems that do not associate variables and other objects with permission data for the specific device. The processing device can generate an output based on an input. For example, the processing device can receive an electronic and/or digital signal. The processing device can read the signal and perform one or more tasks with the signal, such as performing various functions with data in response to input received by the processing device. The processing device can read from the memory device information needed to perform the functions. For example, the processing device can update a variable from static to dynamic based on a received input and a rule stored as data on the memory device. The processing device can send an output signal to the memory device, and the memory device can store data according to the signal output by the processing device.

The processing device can be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” can be used generically to refer to any or all of the aforementioned specific devices, elements, and/or features of the processing device.

The memory device can be and/or include a computer processing unit register, a cache memory, a magnetic disk, an optical disk, a solid-state drive, and so forth. The memory device can be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

In embodiments, various components of the portfolio management system 101 and the user devices 206 can include data communication capabilities. Such capabilities can be rendered by various electronics for transmitting and/or receiving electronic and/or electromagnetic signals. For example, various components of the portfolio management system 101 and the user devices 204 can include one or more communication devices. The communication device can include, for example, a networking chip, one or more antennas, and/or one or more communication ports. The communication device can generate radio frequency (RF) signals and transmit the RF signals via one or more of the antennas. The communication device can receive and/or translate the RF signals. The communication device can transceiver the RF signals. The RF signals can be broadcast and/or received by the antennas. The communication device can generate electronic signals and transmit the RF signals via one or more of the communication ports. The communication device can receive the RF signals from one or more of the communication ports. The electronic signals can be transmitted to and/or from a communication hardline by the communication ports. The communication device can generate optical signals and transmit the optical signals to one or more of the communication ports. The communication device can receive the optical signals and/or can generate one or more digital signals based on the optical signals. The optical signals can be transmitted to and/or received from a communication hardline by the communication port, and/or the optical signals can be transmitted and/or received across open space by the networking device.

The communication device can include hardware and/or software for generating and communicating signals over a direct and/or indirect network communication link. For example, the communication component can include a USB port and a USB wire, and/or an RF antenna with Bluetooth™ programming installed on a processor, such as the processing component, coupled to the antenna. In another example, the communication component can include an RF antenna and programming installed on a processor, such as the processing device, for communicating over a Wifi and/or cellular network. As used herein, “communication device” “communication component,” and/or “communication unit” can be used generically herein to refer to any or all of the aforementioned elements and/or features of the communication component.

Various of the elements in the portfolio management system 101 can be referred to as a “server.” Such elements can include a server device. The server device can include a physical server and/or a virtual server. For example, the server device can include one or more bare-metal servers. The bare-metal servers can be single-tenant servers or multiple tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers. The term server can refer to functionality of a device and/or an application operating on a device. For example, an application server can be programming instantiated in an operating system installed on a memory device and run by a processing device. The application server can include instructions for receiving, retrieving, storing, outputting, and/or processing data. A processing server can be programming instantiated in an operating system that receives data, applies rules to data, makes inferences about the data, and so forth. Servers referred to separately herein, such as an application server, a processing server, a collaboration server, a scheduling server, and so forth can be instantiated in the same operating system and/or on the same server device. Separate servers can be instantiated in the same application or in different applications.

Various aspects of the systems described herein can be referred to as “data.” Data can be used to refer generically to modes of storing and/or conveying information. Accordingly, data can refer to textual entries in a table of a database. Data can refer to alphanumeric characters stored in a database. Data can refer to machine-readable code. Data can refer to images. Data can refer to audio. Data can refer to, more broadly, a sequence of one or more symbols. The symbols can be binary. Data can refer to a machine state that is computer readable. Data can refer to human-readable text.

In some embodiments the method, methods, and/or processes described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

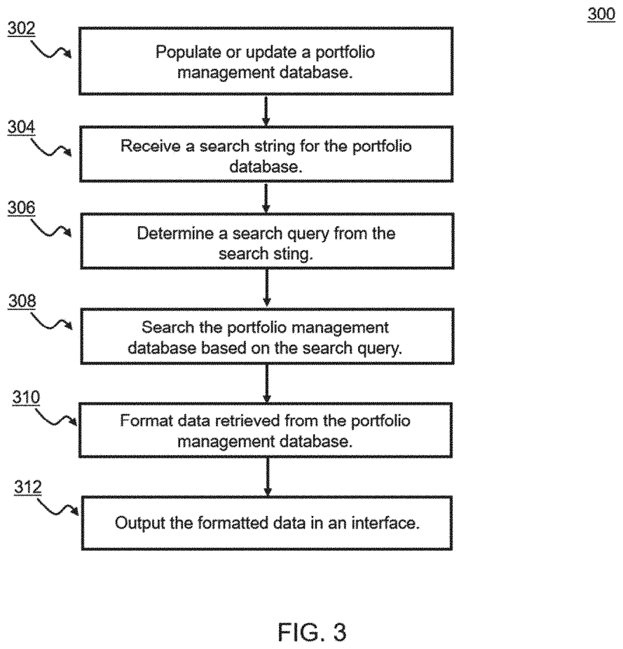

FIG. 3 illustrates a flow diagram of a portfolio management process 300 in accordance with an exemplary embodiment of the present disclosure. In embodiments, the portfolio management process 300 can be performed by the portfolio management system 101, which communicates with the policy system 120, the risk engineering system 130, and the claim system 140. While FIG. 3 illustrates various stages of the portfolio management process 300, additional stages can be added, and existing stages can be removed or reordered.

In 302, a portfolio management database can be populated and/or updated. For example, if the portfolio management system 101 is being operated for the first time, the portfolio management system 101 can communicate with the policy system 120, the risk engineering system 130, the claim system 140, and/or the customer valuation system 150 to extract data (e.g., data records) from the product database 122, the policy database 124, the risk engineering database 132, the claim database 142, and/or the customer valuation database 152. The portfolio management system 101 can request, retrieve, or receive data records that are stored in the product database 122, the policy database 124, the risk engineering database 132, the claim database 142, and the customer valuation database 152 to populate the portfolio management database 103 with information on insurance policies, insurance products, risk, insurance claims.

If the portfolio management database 103 has been previously populated, the portfolio management system 101 can update the portfolio management system 101 with any new or updated data from the product database 122, the policy database 124, the risk engineering database 132, the claim database 142, and the customer valuation database 152. If the update includes any new information, the portfolio management system 101 can create new records and populate the records with the new data. The portfolio management system 101 can perform the update periodically or on-demand.

In any situation, the portfolio management system 101 determines relevant data records from the product database 122, the policy database 124, the risk engineering database 132, the claim database 142, and the customer valuation database 152. The portfolio management system 101 converts the data records from the product database 122, the policy database 124, the risk engineering database 132, the claim database 142, and the customer valuation database 152 into a new standardized format for the portfolio management database 103. To achieve this, the portfolio management system 101 is configured to utilize a multi-layer matching approach combining geocoding input, address standardization, natural language processing, and business rules (e.g., customer or portfolio population density).

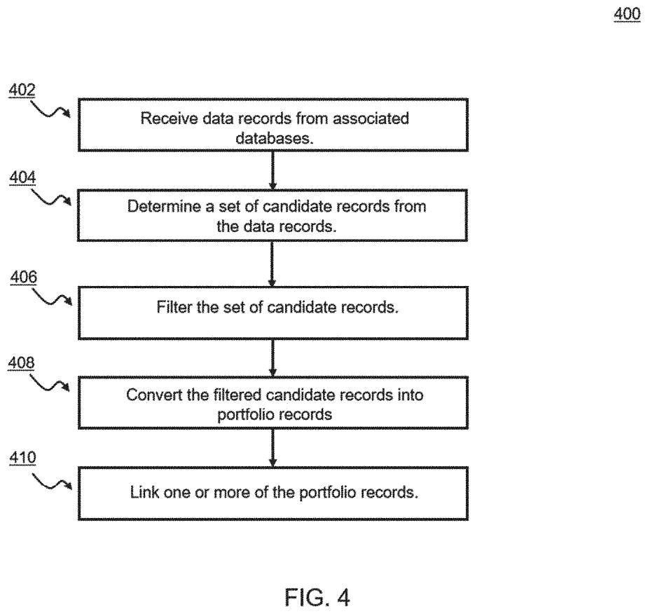

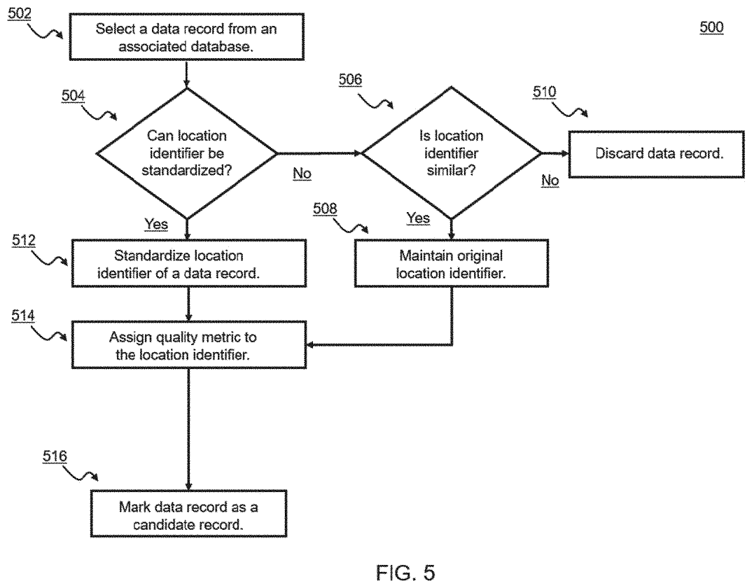

As described below in FIGS. 4 and 5 in further detail, the portfolio management system 101 is configured to determine matching candidates from the product database 122, the policy database 124, the risk engineering database 132, the claim database 142, and the customer valuation database 152 (e.g., data records) by utilizing a set of matching rules to narrow down the number of potential matches. In one embodiment, the matching rules can be a set of business rules, e.g., insurance-specific policy and location characteristics. As such, the portfolio management system 101 can achieve scale and full end-to-end automation.

In some embodiments, the portfolio management system 101 can utilize external data sources to import the data from the product database 122, the policy database 124, the risk engineering database 132, the claim database 142, and the customer valuation database 152. For example, the product database 122, the policy database 124, the risk engineering database 132, the claim database 142, and the customer valuation database 152 can communicate the external data sources 150 to determine data that may be relevant to importing data. For instance, the portfolio management system 101 retrieves geographic location data, historical climate data, financial information, and property valuation information from external data sources (e.g., google maps, commercial data services, governmental data sources, etc.). The data from the external data sources can be utilized to find matching data records to import into the portfolio management database 103.

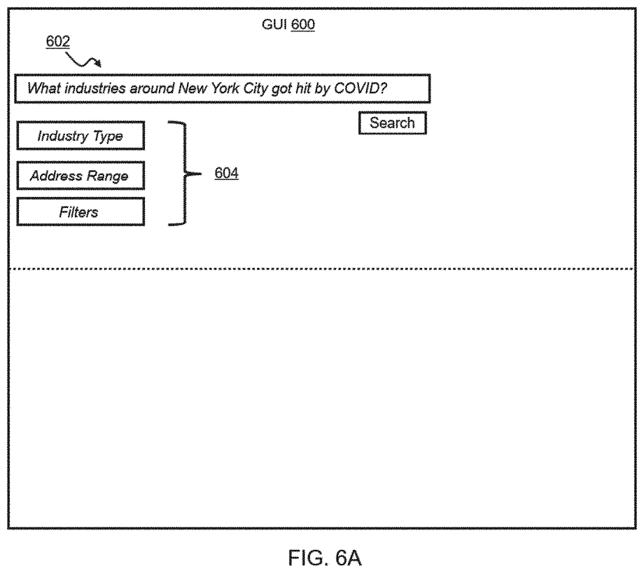

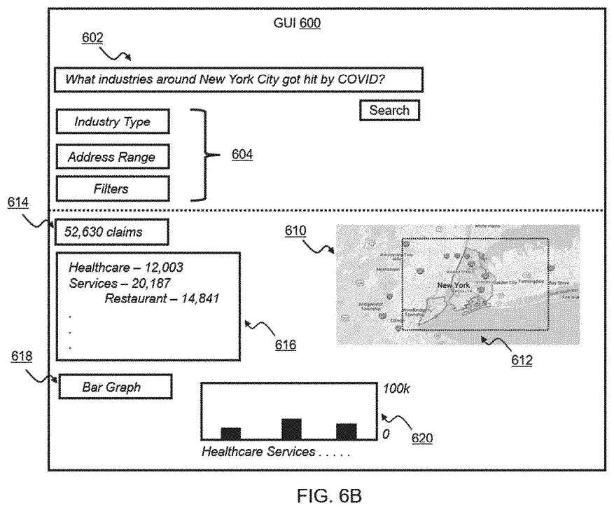

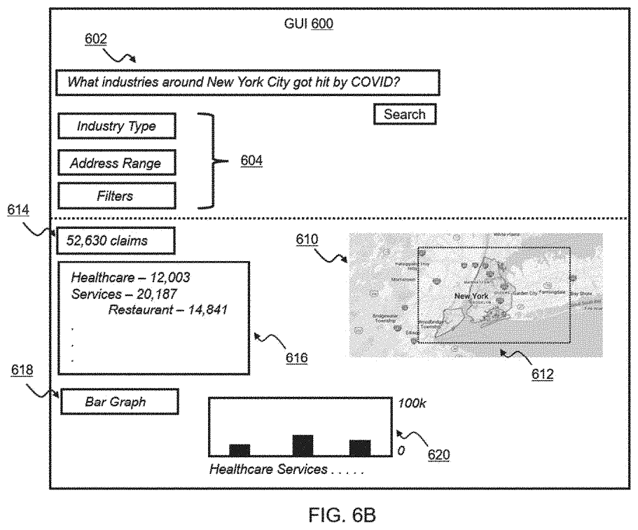

In 304, a search string can be received for searching the portfolio database. In embodiments, a user can communicate with the portfolio management system 101. For example, a user can communicate with the portfolio management system 101 using a user device 206. In some embodiments, the portfolio management system 101 can generate a user interface that includes a search function and provide the user interface to the user. In embodiments, the search string can be any combination of alphanumeric symbols. FIGS. 6A and 6B illustrate an example of a GUI 600 that can be generated and updated by the portfolio management system 101, which is described below in further detail. As illustrated in FIG. 6A, the GUI 600 can include a text box 602 for entering a search string. The GUI 600 can also include other fields 604 for providing parameters and/or filters to the search. The GUI 600 can be generated by the portfolio management system 101 and provided to the user device 106 for display and/or presentation.

For example, a user may desire to determine the impact of a certain event on a certain geographic location, and determine the impacts on the insurer 102 or the customer 104. For instance, a user can enter a natural language search string such as “Have the locations hit by Hurricane Laura been Risk Engineered for Wind?” or “What industries around New York City got hit by COVID?” This user can enter a search string into the text box 602 of the GUI 600 using an interface of the user device 106.

In 306, a search query can be determined from the search string. In embodiments, the portfolio management system 101 can parse the search string and identify keywords for a search of the portfolio management database 103. The keywords can be selected based on a set of search rules or algorithms that specify relevant terms or phrases for the data stored in the portfolio management database 103. The portfolio management system 101 can then form a search query for the portfolio management database 103 from the terms and phrases.

For example, if the user enters the search string “What industries around New York City got hit by COVID?” The portfolio management system 101 can parse the search string and determine the search terms to be “Industries”, “New York City”, “around”, and “COVID”.

In 308, the portfolio management database can be searched based on the search query. In embodiments, the portfolio management system 101 can search the portfolio management database 103. Based on a set of search algorithms and logic that are tailored for the insurance industry. In some embodiments, the portfolio management system 101 can utilize a confidence score for different types of matches allowing to leverage of different inputs depending on the specific analytical use case. For example, the portfolio management system 101 can utilize broad matching for initial trend analysis vs strict matching for regulatory purposes.

For example, for the “Industries”, “New York”, “around”, and “COVID”, the searching algorithms may recognize that New York is a densely populated area and apply a more stringent geographic location match to capture industries and businesses that have similar location identifiers. This is due, in part, to New York being a densely populated area and there being more potential matching candidates.

In 310, data retrieved from the portfolio management database can be formatted. In embodiments, the portfolio management system 101 can extract the matching data records from the portfolio management database 103. In some embodiment, the data records in the portfolio management database 103 can include a link to another database, for example, the product database 122, the policy database 124, the risk engineering database 132, the claim database 142, and the portfolio management system 101 can extract the data from the other database.

In 312, the formatted data can be output in an interface. In embodiments, the portfolio management system 101 can format the data in tables, graphs, charts, etc. that provide the data to the user in a meaningful and useful visual presentation.

For example, as illustrated in FIG. 6B, the portfolio management system 101 can update the GUI 600 with the results of the search. The GUI 600 can include an interactive map 610 that illustrates the geographic area of the search results. The interactive map 610 includes a search area tool 612 that defines the geographic boundaries of the search. Additionally, the GUI 600 can display the results in various fields and charts. For example, the GUI 600 can include a field 614 that lists the number of claims located and a field 616 that list the industries and the number of claims in the industries. The field 614 and the field 616 can include active links to the underlying data. For instance, a user 104 can click on the number of claims in field 614 to view of list of all the claims including details. Likewise, a user 104 can click on a specific industry in the field 616 to view a list of the claims for that industry and the details. The GUI 600 can also include a field 618 that allows a selection of a graphical display of the data. For instance, the GUI 600 can include a bar graph 620 that graphically displays the data. A user 104 can change the type of graphical representation by making a different selection in field 618.

The GUI can also be updated as the user refines the search. For example, the user can modify the search string in field 602 or add a filter or parameter in fields 604. Likewise, as illustrated in FIG. 6C, a user 104 can change the geographic search area using the search area tool 612. In response, as illustrated, the portfolio management system 101 can update the results based on the user's selection.

FIGS. 4 and 5 illustrate flow diagrams of a process 400 of importing data into the portfolio management database and a process 500 of determining candidates for import in accordance with an exemplary embodiment of the present disclosure. In embodiments, the process 400 and the process 500 can be performed by the portfolio management system 101, which communicates with the policy system 120, the risk engineering system 130, the claim system 140, and the customer valuation system 150. While FIGS. 4 and 5 illustrates various stages of the process 400 and the process 500, additional stages can be added and existing stages can be removed or reordered.

In 402, data records can be received from an associated database. In embodiments, the portfolio management system 101 can communicate with the policy system 120, the risk engineering system 130, the claim system 140, and/or the customer valuation system 150 to extract data (e.g., data records) from the product database 122, the policy database 124, the risk engineering database 132, the claim database 142, and/or the customer valuation database 152. The portfolio management system 101 can request, retrieve, or receive data records that are stored in the product database 122, the policy database 124, the risk engineering database 132, the claim database 142, and the customer valuation database 152.

In 404, a set of candidate records can be determined from the data records retrieved. In embodiments, the portfolio management system 101 determines relevant data records from the product database 122, the policy database 124, the risk engineering database 132, the claim database 142, and the customer valuation database 152. The portfolio management system 101 converts the data records from the product database 122, the policy database 124, the risk engineering database 132, and the claim database 142 into a new standardized format for the portfolio management database 103. To achieve this, the portfolio management system 101 is configured to utilize a multi-layer matching approach combining geocoding input, address standardization, natural language processing, and business rules (e.g., customer or portfolio population density). The portfolio management system 101 is configured to determine matching candidates from the product database 122, the policy database 124, the risk engineering database 132, the claim database 142, and the customer valuation database 152 (e.g., data records) by utilizing a set of matching rules to narrow down the number of potential matches. In one embodiment, the matching rules can be a set of business rules, e.g., insurance-specific policy and location characteristics.

In embodiments, the portfolio management system 101 can receive the data records from the product database 122, the policy database 124, the risk engineering database 132, the claim database 142, and the customer valuation database 152 and standardize information of customers, policies, and locations from a high number of local and above country data sources and initial information mapping. The algorithms and logic used by the portfolio management system 101 can include rules and mapping that can identify and transform data records from system of the insurer at different maturity stages, from mainframes to modern web applications, and that use different data formats. Additionally, the portfolio management system 101 can link and integrate policy and customer information allowing to uniquely identify the customer and policy entities independent of the data source used.

In embodiments, the portfolio management system 101 uses a series of algorithms logic from simple integration to stochastic matching allowing to account for data inaccuracy at policy and customer level, e.g., incorrect unique IDs in the underlying applications. The portfolio management system 101 propagates rules allowing to identify and prioritize the most accurate information available for each of the relevant dimensions, e.g., address, customer hierarchy.

For example, the set of candidate records can be determined using process 500. In 502, a data record from an associated database can be selected. In embodiments, the portfolio management system 101 can select a data record from the product database 122, the policy database 124, the risk engineering database 132, the claim database 142, and/or the customer valuation database 152 for processing.

In 504, it can be determined if a location identifier can be standardized. If the location identifier can be standardized, in 512, the location identifier can be standardized. In embodiments, the portfolio management system 101 can utilize a combination of geocoding services, standardization rules, and modeling methods to standardize addresses on a global scale. For example, a data record may contain a location identifier, e.g., address, “5^{th} Ave NY” and “fifth avenue New York” or “Leihstr.” and “Leihstrasse”. The portfolio management system 101 can standardize these location identifiers based on standardization rules, for example, “5^{th} ave NY” and “fifth avenue New York” is converted to “5^{th} (fifth) Avenue, New York City, New York.”

If the location identifier cannot be standardized, in 506, it can be determined if the location identifier is similar to a standardized location identifier. If the location identifier is within the threshold, in 508, the original location identifier can be maintained. If the location identifier is not within the threshold, in 510, the data record can be discarded. In embodiments, the portfolio management system 101 can compare the location identifier to a similarity rule. The similarity rules can be based a number of factors including the geographic location of the location identifier in question, the qualitative difference between the location identifier and standardized location identifier, and the like. For example, a data record may contain a location identifier, e.g., address, “108 5^{th}, New York City, New York”. Because New York City has a 5^{th} Avenue and a 5^{th} Street, the portfolio management system 101 cannot standardize or completely standardize the location identifier. Because the location identifier can potentially match a valid location, the portfolio management system 101 can leave the location identifier as “108 5^{th}, New York City, New York.”

In 514, the location identifier can be assigned a quality metric, and, in 516, the data record can be marked as a candidate data record. The quality metric can be a numeric value that represents the likelihood that the location identifier is valid. In embodiments, the portfolio management system 101 can assign the quality metric based on a set of quality metric rules. The quality metric rules can provide logic to determine the quality metric-based factors such as the standardization of the location identifier, the location identifier's probability of being a valid location identifier within the context of the data record, geographic location, etc. For example, if an address is standardized, the location identifier can be given a high-quality metric. In another example, a location identifier may not be standardized fully, e.g., in the above example “108 5^{th}, New York City, New York”, but can be given a high-quality metric because the location identifier has a high probability of being valid.

Returning to process 400 illustrated in FIG. 4, in 406, the set of candidate records can be filtered. In embodiments, the portfolio management system 101 can filter the candidate records from the process 500 to ensure that only portfolios in scope added to the portfolio management database 103. The portfolio management system 101 can utilize a set of filtering rules to select the candidate records. In some embodiments, the portfolio management system 101 can use a set of business rules and location entity characteristics to narrow down the number of potential matching candidates. For example, the portfolio management system 101 can select candidate data records that have a quality metric (e.g., good quality addresses within the same portfolio with “Berlin” as a city). In another example, while “108 5^{th}, New York City, New York” has a high-quality metric, the portfolio management system 101 may not select “108 5^{th}, New York City, New York” because all alternatives of the address “108 5^{th} Ave, New York City, New York” and “108 5^{th} St. New York City, New York” correspond to residential property, and the insurer 102 only offers commercials insurance products. Additionally, the customer may be a manufacturing company with no residential buildings in its portfolio.

In 408, the filtered candidate records can be converted into portfolio records. In embodiment, the portfolio management system 101 can extract data from the filter candidate records and import the data into a data record of the portfolio management database 103. The portfolio management system 101 can utilize data mapping algorithms and logic to transfer data from fields of the filtered candidate records to data fields of the data records of the portfolio management database 103. In some embodiments, the portfolio management system 101 can transfer the actual data to the data records of the portfolio management database 103. In some embodiments, the portfolio management system 101 can transfer links to data to the data records of the portfolio management database 103.

In 410, one or more of the portfolio records can be linked. In embodiments, the portfolio management system 101 uses rules that link the data within the data records. For example, the portfolio management system 101 can apply a multi-layer scoring algorithm based on address components, location, and modeled information (e.g., Natural Language Processing embedding) to prioritize the best linking suggestion from the entire pool of linking candidates. The algorithms of the portfolio management system 101 can consider typical user mistakes, e.g., incorrect street numbers and postal codes. The portfolio management system 101 can also utilize additional business rules for linking data records. For example, the business rules can include geographic factors such as low density of potential matches (customer locations) within a given geographical area favors more aggressive linking approaches (as geocoding accuracy decreases in less populated areas) and candidate pool size, e.g., if the claim address is not accurate—the only city is listed as “New York” and there is only one location in New York, link locations. The generated data may be output to a user device, such as a GUI of device 206, as described herein.

FIG. 7 illustrates an exemplary computing device 700 that can be used to implement the methods and/or as any of the computing devices described herein. The computing device 700 can include one or more processing devices 702 configured to execute instructions with respect to data. For example, the one or more processing devices 702 can be central processing units (CPU), graphics processing units (GPU), application specific integrated circuits (ASICS), field programmable gate array (FPGA) or other type of processing device.

The one or more processing devices 702 can be connected to a bus 704, such as a peripheral connect interface (PCI) bus or other type of bus. A non-volatile storage device 706 and volatile memory 708 can be connected to the one or more processing devices 702, such as by means of the bus 704. The non-volatile storage device 706 can include a hard disk drive (HDD), solid state drive (SSD), or other type of non-volatile storage device. The volatile memory 708 can include a random-access memory (RAM), such as dynamic RAM (DRAM) or other type of RAM.

Other devices can be connected to the bus 704, such as a network interface 710 for connecting the computing device 700 to a wired or wireless network. A display device 712 can be connected to the bus 704, such as a screen, touch screen, projector, or other display device. One or more input devices 714 can be connected to the bus 704, such as a mouse, keyboard, trackpad, or other type of input device 714.

One or both of the non-volatile storage device 706 and volatile memory 708 can store executable code that, when executed by the one or more processing devices 702, causes the one or more processing devices 702 to perform the methods disclosed herein. The methods disclosed herein can be performed by a computer system including one or more computing devices 700. Where the computer system includes a plurality of computing devices 700, the plurality of computing devices 700 can be connected by a network or chassis backplane.

For purposes of illustration, programs and other executable program components are shown herein as discrete blocks, although it is understood that such programs and components can reside at various times in different storage components 706, 708 of computing device 700, and are executed by the one or more processing devices 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Memory in the processing devices 702 can be allocated dynamically according to variables, variable states, static objects, and permissions associated with objects and variables. Such memory allocation can be based on instructions stored in the memory devices, e.g., volatile memory 708 and/or non-volatile storage devices 706. Memory resources at a specific device can be conserved relative to other systems that do not associate variables and other objects with permission data for the specific device. The processing devices 702 can generate an output based on an input. For example, the processing device can receive an electronic and/or digital signal. The processing devices can read the signal and perform one or more tasks with the signal, such as performing various functions with data in response to input received by the processing device. The processing devices can read from memory devices, e.g., volatile memory 708 and/or non-volatile storage devices 706, information needed to perform the functions. For example, the processing devices 702 can update a variable from static to dynamic based on a received input and a rule stored as data on the memory device. The processing devices 702 can send an output signal to the memory devices, e.g., volatile memory 708 and/or non-volatile storage devices 706, and the memory device can store data according to the signal output by the processing device.

Some embodiments of the disclosure may be described as a system, method, apparatus, or computer program product. Accordingly, embodiments of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in one or more computer readable storage media, such as a non-transitory computer readable storage medium, having computer readable program code embodied thereon.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together but may comprise disparate instructions stored in different locations which, when joined logically, or operationally, together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. The system or network may include non-transitory computer readable media. Where a module or portions of a module are implemented in software, the software portions are stored on one or more computer readable storage media, which may be a non-transitory media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing, including non-transitory computer readable media.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray Disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals.

Embodiments of the present disclosure concern a portfolio manager which can easily identify and access all the relevant information to provide complete and accurate advice to customers as well as manage the portfolio for profitability.

Embodiment 1 is directed to a computer-implemented method for outputting result data to an output device. The method includes using at least one hardware processor for extracting code for: populating a portfolio management database with one or more data records from at least one database, where populating the portfolio management database includes at least one of: altering at least a portion of the one or more data records, and selecting a portion of the one or more data records based on one or more rules for the portfolio management database. The method includes receiving at least one search string associated with a search of the portfolio database management database. The method also includes searching the portfolio database based on the at least one search string. The method includes generating result data based, at least in part, on the searching and outputting result data to a user interface.

Embodiment 2 is directed to the computer-implemented method, where populating the portfolio management database comprises initially populating the portfolio management database.

Embodiment 3 is directed to the computer-implemented method, where populating the portfolio management database comprises updating the portfolio management database.

Embodiment 4 is directed to computer-implement method, where the one or more data records include property valuations and the method further includes comparing a current property valuation to a historic property valuation; determining that the current property valuation differs from the historic property valuation; and generating a report of a difference in the current property valuation and the historic property valuation.

Embodiment 5 is directed to the computer-implemented method, where populating the portfolio management database includes: determining a set of candidate data records from the one or more data records, where the determination of the set of candidate data records is based, at least in part, on a standardization of one or more geographic location identifiers of the one or more data records; filtering the set of candidate data records, where filtering the set of candidate records is based, at least in part, on a set of relevancy rules for the portfolio management database; converting the set of candidate data records, which were filtered, into one or more portfolio data records; and linking one or more portfolio data records based, at least in part, on the converting.

Embodiment 6 is directed to the computer-implemented method, where determining the set of candidate data records includes: selecting a first data record from the one or more data records; determining whether a first geographic location identifier in the first data record can be standardized into a format of the portfolio management database; if the first geographic location identifier can be standardized, standardizing the first geographic location identifier according to the format of the portfolio management database; assigning a first quality metric to the first geographic location identifier, which was standardized, identifier based, at least in part, on one or more quality metric rules; and marking the first data record for inclusion in the set of candidate data records.

Embodiment 7 is directed to the computer-implemented method, where determining the set of candidate data records includes: if the first geographic location identifier cannot be standardized, determining whether the first geographic location identifier is similar to at least one valid geographic location based on one or more geographic location identifier rules; if the first geographic location identifier is not similar, discarding the first data record; if the first geographic location identifier is similar, maintaining the geographic location identifier for the first data record; and assigning a second quality metric to the first geographic location identifier.

Embodiment 8 is directed to the computer-implemented method, where the searching further includes selecting one or more matching candidates from the portfolio management database, based, at least in part, on a set of business rules.

Embodiment 9 is directed to the computer-implemented method, where the set of business rules include insurance-specific policy characteristics.

Embodiment 10 is directed to the computer-implemented method, where the set of business rules includes location characteristics.

Embodiment 11 is directed to the computer-implemented method, where the searching includes utilizing a confidence score.

Embodiment 12 is directed to the computer-implemented method, where the searching combines complex data and granular data.

Embodiment 13 is directed to the computer-implemented method, further including receiving an update to the at least one search string; generating new result data based, at least in part, on the update to the at least one search string; and updating the user interface based on the new result data.

Embodiment 14 is directed to a method for consolidating data records from multiple databases, including receiving one or more data records to be transferred from at least one database to a portfolio management database. The method includes determining a set of candidate data records from the one or more data records. The determination of the set of candidate data records is based on at least a standardization of one or more geographic location identifiers of the one or more data records. The method also includes filtering the set of candidate data records. Filtering the set of candidate records is based on a set of relevancy rules for the portfolio management database. Further, the method includes converting the filtered set of candidate data records into one or more portfolio data records. The method includes linking a set of the one or more portfolio data records and outputting the linked sets of portfolio data records to a user device.

Embodiment 15 is directed to the method for consolidating data records from multiple databases, where determining the set of candidate data records includes: selecting a first data record from the one or more data records; determining whether a first geographic location identifier in the first data record can be standardized into a format of the portfolio management database; if the first geographic location identifier can be standardized, standardizing the first geographic location identifier according to the format of the portfolio management database; assigning a first quality metric to the first geographic location identifier, which was standardized, based on one or more quality metric rules; and marking the first data record for inclusion in the set of candidate data records.

Embodiment 16 is directed to the method for consolidating data records from multiple databases, where the selecting further comprises selecting one or more matching candidates from the portfolio management database, based, at least in part, on a set of business rules.

Embodiment 17 is directed to the method for consolidating data records from multiple databases, where determining the set of candidate data records includes: if the first geographic location identifier cannot be standardized, determining whether the first geographic location identifier is similar to at least one valid geographic location based on one or more geographic location identifier rules; if the first geographic location identifier is not similar, discarding the first data record; if the first geographic location identifier is similar, maintaining the geographic location identifier for the first data record; and assigning a second quality metric to the geographic location identifier.

Embodiment 18 is directed to a system for consolidating data records, including: one or more memories configured to store representations of data in an electronic form; and one or more processors, operatively coupled to one or more of the memories, the processors configured to access the data and process the data to: select a data record to be transferred from a first database to a portfolio management database; determine whether a geographic location identifier in the data record can be standardized into a format of the portfolio management database; if the geographic location identifier can be standardized, standardizing the geographic location identifier according to the format of the portfolio management database; assign a first quality metric to the geographic location identifier, which was standardized, identifier based on one or more quality metric rules; mark the data record as a candidate data record; and output the marked data record to a user device.

Embodiment 19 is directed to the system, where the selecting further includes selecting one or more matching candidates from the portfolio management database, based, at least in part, on a set of business rules.

Embodiment 20 is directed to the system, where the set of business rules includes insurance-specific policy characteristics.

Embodiment 21 is directed to the system, further including: if the geographic location identifier cannot be standardized, determining whether the geographic location identifier is similar to at least one valid geographic location based on one or more geographic location identifier rules; if the geographic location identifier is similar, discarding the data record; and if the geographic location identifier is not similar, maintaining the geographic location identifier for the candidate data record and assigning a second quality metric to the geographic location identifier.

Certain terminology is used in the following description for convenience only and is not limiting. Unless specifically stated otherwise as apparent from the above discussion, it is appreciated that throughout the description, discussions utilizing terms such as “identifying” or “calculating” or “determining” or “executing” or “performing” or “collecting” or “creating” or “sending” or the like, refer to the action and processes of an electronic system, a computer system, or similar electronic computing device, that manipulates and transforms data represented as physical (electronic) quantities within the computer system's registers and memories into other data similarly represented as physical quantities within the computer system memories or registers or other such information storage devices.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which can be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that can include: A alone; A and B; A, B and C; A, B, C, and D; and so forth. The bounds of an “and/or” list are defined by the complete set of combinations and permutations for the list.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as disclosed above and claimed.

What is claimed is:

1. A computer-implemented method for outputting result data to an output device, the method comprising:
using at least one hardware processor for extracting code for:
populating a portfolio management database with one or more data records from at least one database, wherein populating the portfolio management database comprises at least one of:
altering at least a portion of the one or more data records, and
selecting a portion of the one or more data records based on one or more rules for the portfolio management database;
receiving at least one search string associated with a search of the portfolio database management database;
searching the portfolio database based on the at least one search string;
generating result data based, at least in part, on the searching; and
outputting result data to a user interface.

2. The computer-implemented method of claim 1, wherein populating the portfolio management database comprises initially populating the portfolio management database or updating the portfolio management database.

3. The computer-implemented method of claim 1, wherein the one or more data records include property valuations and the method further comprises:
comparing a current property valuation to a historic property valuation;
determining that the current property valuation differs from the historic property valuation; and
generating a report of a difference in the current property valuation and the historic property valuation.

4. The computer-implemented method of claim 1, wherein populating the portfolio management database comprises:
determining a set of candidate data records from the one or more data records, wherein the determination of the set of candidate data records is based, at least in part, on a standardization of one or more geographic location identifiers of the one or more data records;
filtering the set of candidate data records, wherein filtering the set of candidate records is based, at least in part, on a set of relevancy rules for the portfolio management database;
converting the set of candidate data records, which were filtered, into one or more portfolio data records; and
linking one or more portfolio data records based, at least in part, on the converting.

5. The computer-implemented method of claim 4, wherein determining the set of candidate data records comprises:
selecting a first data record from the one or more data records;
determining whether a first geographic location identifier in the first data record can be standardized into a format of the portfolio management database;
if the first geographic location identifier can be standardized, standardizing the first geographic location identifier according to the format of the portfolio management database;
assigning a first quality metric to the first geographic location identifier, which was standardized, identifier based, at least in part, on one or more quality metric rules; and
marking the first data record for inclusion in the set of candidate data records.

6. The computer-implemented method of 5, wherein determining the set of candidate data records comprises:
if the first geographic location identifier cannot be standardized, determining whether the first geographic location identifier is similar to at least one valid geographic location based on one or more geographic location identifier rules;
if the first geographic location identifier is not similar, discarding the first data record;
if the first geographic location identifier is similar, maintaining the geographic location identifier for the first data record; and
assigning a second quality metric to the first geographic location identifier.

7. The computer-implemented method of claim 1, wherein the searching further comprises selecting one or more matching candidates from the portfolio management database, based, at least in part, on a set of business rules.

8. The computer-implemented method of claim 7, wherein the set of business rules includes insurance-specific policy characteristics.

9. The computer-implemented method of claim 7, wherein the set of business rules includes location characteristics.

10. The computer-implemented method of claim 1, wherein the searching includes utilizing a confidence score.

11. The computer-implemented method of claim 1, wherein the searching combines complex data and granular data.

12. The computer-implemented method of claim 1, the method further comprising:
receiving an update to the at least one search string;
generating new result data based, at least in part, on the update to the at least one search string; and
updating the user interface based on the new result data.

13. A method for consolidating data records from multiple databases, comprising:
receiving one or more data records to be transferred from at least one database to a portfolio management database;
determining a set of candidate data records from the one or more data records, wherein the determination of the set of candidate data records is based on at least a standardization of one or more geographic location identifiers of the one or more data records;
filtering the set of candidate data records, wherein filtering the set of candidate records is based on a set of relevancy rules for the portfolio management database;
converting the filtered set of candidate data records into one or more portfolio data records;
linking a set of the one or more portfolio data records; and
outputting the linked sets of portfolio data records to a user device.

14. The method of claim 13, wherein determining the set of candidate data records comprises:
selecting a first data record from the one or more data records;
determining whether a first geographic location identifier in the first data record can be standardized into a format of the portfolio management database;
if the first geographic location identifier can be standardized, standardizing the first geographic location identifier according to the format of the portfolio management database;
assigning a first quality metric to the first geographic location identifier, which was standardized, based on one or more quality metric rules; and
marking the first data record for inclusion in the set of candidate data records.

15. The method of claim 14, wherein the selecting further comprises selecting one or more matching candidates from the portfolio management database, based, at least in part, on a set of business rules.

16. The method of claim 14, wherein determining the set of candidate data records comprises:
if the first geographic location identifier cannot be standardized, determining whether the first geographic location identifier is similar to at least one valid geographic location based on one or more geographic location identifier rules;
if the first geographic location identifier is not similar, discarding the first data record;
if the first geographic location identifier is similar, maintaining the geographic location identifier for the first data record; and
assigning a second quality metric to the geographic location identifier.

17. A system for consolidating data records, comprising:
one or more memories configured to store representations of data in an electronic form; and
one or more processors, operatively coupled to one or more of the memories, the processors configured to access the data and process the data to:
select a data record to be transferred from a first database to a portfolio management database,
determine whether a geographic location identifier in the data record can be standardized into a format of the portfolio management database,
if the geographic location identifier can be standardized,
standardizing the geographic location identifier according to the format of the portfolio management database,
assign a first quality metric to the geographic location identifier, which was standardized, identifier based on one or more quality metric rules,
mark the data record as a candidate data record, and
output the marked data record to a user device.

18. The system of claim 17, wherein the selecting further comprises selecting one or more matching candidates from the portfolio management database, based, at least in part, on a set of business rules.

19. The system of claim 18, wherein the set of business rules includes insurance-specific policy characteristics.

20. The system of claim 17, further comprising:
if the geographic location identifier cannot be standardized, determining whether the geographic location identifier is similar to at least one valid geographic location based on one or more geographic location identifier rules;
if the geographic location identifier is similar, discarding the data record; and
if the geographic location identifier is not similar, maintaining the geographic location identifier for the candidate data record and assigning a second quality metric to the geographic location identifier.
